(19) United States
(12) Patent Application Publication
(10) Pub. No.: US 2007/0155202 A1
(43) Pub. Date: Jul. 5, 2007

(54) Supported insertion type spindle

(76) Inventor: Wei-Chieh Chuang, Hsin Chang City (TW)

Correspondence Address: TROXELL LAW OFFICE PLLC;ONE SKYLINE PLACE, SUITE 1404, 5205 LEESBURG PIKE, FALLS CHURCH, VA, 22041, US

(21) Appl. No.: 11/526,082

(22) Filed: Sep. 25, 2006

(30) Foreign Application Priority Data
Oct. 18, 2005 (TW) 094217953

(51) Int. Cl. H01R 13/44

(52) U.S. Cl. 439/131

(57) ABSTRACT

The present invention discloses a supported insertion type spindle, comprising a male connection member which is a rod having a hollow axle extending interiorly and axially, at least a cut groove fabricated horizontally, and a connection portion protrudingly formed on its exterior; a female connection member which is a tubular body having an axial hole laterally on its exterior to be fittingly connected with the axle through a close fit, and a connection portion protrudingly extending on its exterior; and at least a support which a frame having a tenon hole fabricated vertically on its frame plate for the insertion of and riveting with the connection portions of the male and/or female connection members and thus riveting together the support with the male and/or female connection members, and a frame board horizontally extending from the frame plate having a jointing portion, such that the two connection members have an elevational difference between them due to the extension of the support.

### FIELD OF THE INVENTION

The present invention relates to an insertion type spindle and more particular to an insertion type spindle with a support which can change the position of the connection between the spindle and object to have the flexible operation space.

### BACKGROUND OF THE INVENTION

Consumer electronics with flip covers, such as portable computer, electronic dictionary, portable audio/video player, flip mobile phone, generally have a main body on the bottom, which is pivotally connected with the cover body on the top, such that the cover body may swing open or close with respect to the main body. Consequently, the rotating shaft is key to the quality of the products described above. In fact, the design for a good rotating shaft shall not only demand a necessary arresting effect to prevent loose joint after repetitive operations, but also prevent abnormal sound from occurring to annoy users.

In general, the friction generated by a spindle can be divided into two types. In an in-line spindle (axial friction), an axle is inserted through a L-shape support and then connected in line with an elastic body, a spring or a belleville washer for example. A packing is finally connected with the axle to press against the aforementioned elastic body and thus to achieve arresting and positioning functions due to axial friction. The structural advantage of the in-line spindle is in that the support and the axle are connected with different objects, a main body and a cover body for example, respectively, to have an elevational difference and thus a flexible operation space. However, since the elastic body, support, and axle are connected without cover, dust, temperature variation, and other factors may induce noise, sluggish movement during operation.

On the other hand, in an insertion spindle (or radial friction), a female connection member is fabricated to form an axle hole and the axle of a male connection is horizontally fabricated to form a cut groove to provide the axle with some extent of flexibility and to facilitate the insertion into the axle hole, such a frictional torque may be generate between the axle and the axle hole. The structural advantage of the insertion spindle is in that the cut groove of the axle can adequately receive lubricating grease, which is encompassed by the axle hole, and thus a long-tern lubrication can be achieve. However, since the male/female connection members are fittingly connected linearly with objects, a main body and a cover body, respectively, they are located in the same plane and thus interfere with the assembly of main board.

Consequently, the applicant has attempted to provide a flexible operation space for the insertion type spindle in order to overcome the drawbacks of the aforementioned spindles. ROC Pat. No. 539,040, titled as “Insertion Type Spindle,” discloses that a fixed part of an insertion type spindle can be secured on and connected with a support through its surface screw with a screwing part, such that the fixed part can be mounted onto the support. Therefore, the movable part inserted into the fixed part will have an elevational difference with respect to the support. This invention combining the advantages of the insertion type spindle and in-line type spindle and expanding the application of the in-line type spindle has been widely accepted in 3C industry.

### SUMMARY OF THE INVENTION

To further improve the aforementioned patent and simplify the number of components for the spindle and support and its assembly, the applicant having a long time experience in designing, production, and marketing of the spindle proposes the present invention, a supported insertion type spindle (2), as a result of numerous trials and experiments.

An object of the present invention is to provide a supported insertion type spindle, comprising a male connection member which is a rod having a hollow axle extending interiorly and axially, at least a cut groove fabricated horizontally, and a connection portion protrudingly formed on its exterior; a female connection member which is a tubular body having an axial hole laterally on its exterior to be fittingly connected with the axle through a close fit, and a connection portion protrudingly extending on its exterior; and at least a support which a frame having a tenon hole fabricated vertically on its frame plate for the insertion of and riveting with the connection portions of the male and/or female connection members and thus riveting together the support with the male and/or female connection members, and a frame board horizontally extending from the frame plate having a jointing portion, such that the two connection members have an elevational difference between them due to the extension of the support.

Another object of the present invention is to provide a supported insertion type spindle, wherein the connection portions of the male and female connection members may be a mill-face stub or a polyhedron. Alternately, the connection portion of the male or female connection members may be fabricated to form at least a hole. Also, an axle ring is disposed between the axle and the connection portion.

Yet another object of the present invention is to provide a supported insertion type spindle, wherein a flange portion is disposed near the free end of the axle and a clip-in portion is disposed corresponding to the axle hole, such that the flange portion and the clip-in portion may be clipped together. Also, the axle is fabricated to form an axle groove, which may be linked with the cut groove to receive lubricating grease.

### BRIEF DESCRIPTION OF THE DRAWINGS

The present invention can be more fully understood by reference to the following description and accompanying drawings, in which:

FIG. 1 schematically illustrates the exploded perspective view of a spindle and a support according to the present invention;

FIG. 2 schematically illustrates the sectional assembly view of FIG. 1; and

FIG. 3 schematically illustrates the perspective assembly view of FIG. 1.

### DETAILED DESCRIPTION OF THE INVENTION

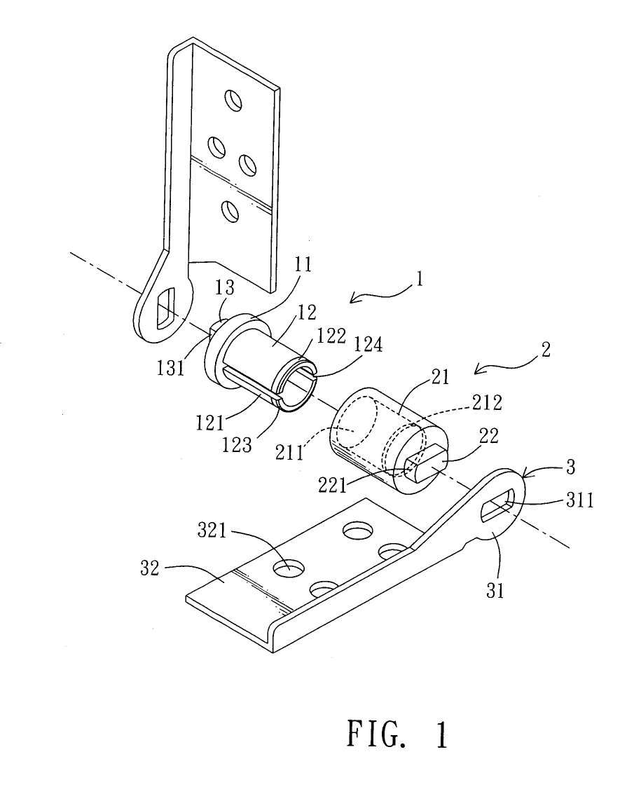

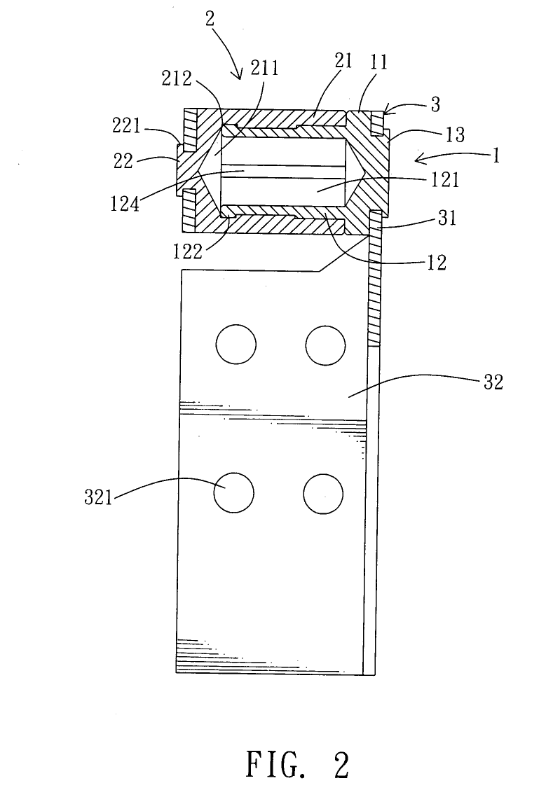

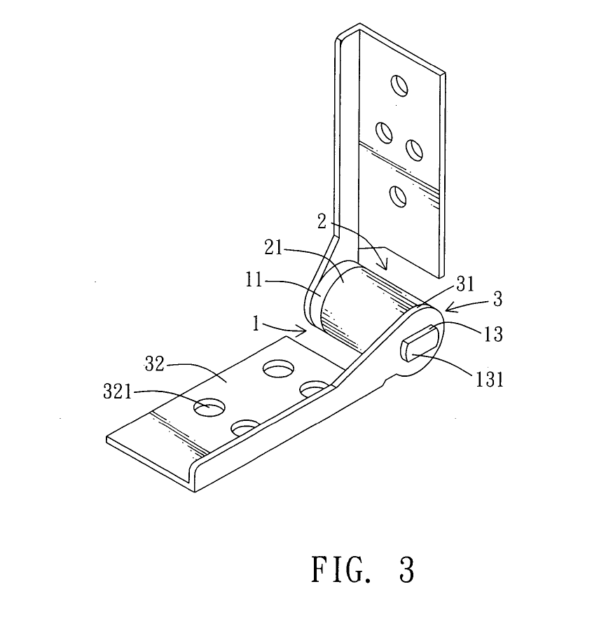

As depicted in FIGS. 1 to 3, the supported insertion type spindle according to the present invention comprises a male connection member 1, a female connection member 2, and at least a support 3.

The male connection member 1 is a prior art protrudingly disposed with an axle ring 11 on one side, which is pressing against the female connection member 2 when the male connection member 1 is insertingly connected with the female connection member 2. The axle ring 11 is extends axially to form a hollow axle 12 along its interior and the axle is horizontally fabricated to form at least a cut groove 121 to provide the axle 12 with an appropriate extent of flexibility. Furthermore, to prevent inserting connection between the male connection member 1 and the female connection member 2 from coming off, a flange portion 122 is disposed near the free end of the axle 12 and the flange portion 122 is disposed with a chamfered portion 123 on its exterior of free end to facilitate the insertion of the axle 12 into the sleeve 21 of the female connection member 2.

A connection portion 13 is disposed on the rear of the axle ring 11 to connect with an object, a cover body for example as depicted in the drawings. The connection portion 13 is, for example but not limited to, a long, round connection tenon 131. The connection portion 13 may also be a mill-face stub or a polyhedron to insertingly connect with the support 3. Alternately, the connection portion 13 may be fabricated to form at least a hole for the insertion of a screw to securingly lock with an object, which is also within the scope of the present invention.

The female connection member 2 is a tubular body having a sleeve 21 on one side, which is fabricated to form an axial hole 211 with a diameter slightly smaller than that of the axle 12. The axle 12 and the axial hole is fittingly connected through a close fit and thus a radial friction is induced between the axle 12 and the inner wall of the sleeve 21 to provide an insertion spindle with the function of arresting and positioning. As depicted in the drawings, the axial hole 211 is stepped with a clip-in portion 212 to clip with the flange 122, such that the male connection member 1 may not disengage from the female connection member 2.

The distinct feature of the female connection member 2 according to the present lies in that the sleeve 21 extends protrudingly to form a connection portion 22, as depicted in the drawings, which is, for example but not limited to, a long cylinder connection tenon 221. The connection portion 22 may also be a mill-face stub or a polyhedron to insertingly connect with the support 3. Alternately, the connection portion 22 may be fabricated to form at least a hole for the insertion of a screw to securingly lock with another object, a main body for example, or to be a supporting stand of an object, a portable multi-media player for example.

The support 3 is a frame, which may be a L-shape body, or a long slender frame as depicted in the drawings. The support plate 31 is fabricated to form a tenon hole 311 whose size and shape is corresponding to the connection tenons 131 and 221 along its vertically direction for the insertion of the connection tenons 131 and 221. When the connection tenon 131 and 221 are inserted into their corresponding tenon holes 311, the support 3 is riveted with the male connection member 1 and/or the female connection member 2 with the stamping the connection tenons 131 or 221 by a jig. An elevational difference exists between the male connection member 1 and the female connection member 2 to extend the flexibility of their application. Furthermore, the support plate 31 extends horizontally from its lower edge to form a frame board 32, which may tailored made according to customers' demand and thus will not be discussed further. The frame board 32 is fabricated at least a board hole 321 for the insertion of a screw to lock with another object, a main body for example, or to be a supporting stand of an object, a portable multi-media player for example.

With further reference to the drawings, when the axle 12 of the male connection member 1 inserted into the axial hole 21 of the female connection member 2 with a close fit, the respective tenon hole 311 of the two longitudinal frame plates 31 are insertingly connected with the connection tenons 131 and 221, which are stamped by a jig, such that the two support 3 are riveted with the male connection member 1 and the female connection member 2 and thus the assembly of the present invention is completed. Furthermore, the axle 12 is fabricated to form an axle groove 124 which is linked with the cut groove 121 to receive lubricating grease, providing lubrication through the cut groove 121.

Consequently, the implementation of the present invention is to connect the male and female connection members of a radial friction spindle with at least a support according to actual demand. Therefore, there is an elevational difference between the male and female connection members, not at the same plane, to meet the demand of assembly process. Also, the spindle according to the present invention is an insertion type, which may prevent dust, temperature, and other factors to induce noise or sluggish movement during the rotating operation. Furthermore, the present invention using riveting to replace conventional art of screwing for connection may reduce the number of components for assembling and connect the male and female connection members with the support according to actual demand.

While the invention has been described with reference to the a preferred embodiment thereof, it is to be understood that modifications or variations may be easily made without departing from the spirit of this invention, which is defined by the appended claims.

What is claimed is:

1. A supported insertion type spindle, comprising
a male connection member which is a rod having a hollow axle extending interiorly and axially, at least a cut groove fabricated horizontally, and a connection portion protrudingly formed on its exterior;
a female connection member which is a tubular body having an axial hole laterally on its exterior to be fittingly connected with the axle through a close fit, and a connection portion protrudingly extending on its exterior; and
at least a support which a frame having a tenon hole fabricated vertically on its frame plate for the insertion of and riveting with the connection portions of the male and/or female connection members and thus riveting together the support with the male and/or female connection members, and a frame board horizontally extending from the frame plate having a jointing portion, such that the two connection members have an elevational difference between them due to the extension of the support.

2. The device as defined in claim 1, wherein an axle ring is disposed between the axle and the connection portion.

3. The device as defined in claim 1, wherein the connection portions of the male and female connection members may be a mill-face stub or a polyhedron

4. The device as defined in claim 1, wherein the connection portion of the male or female connection members may be fabricated to form at least a hole.

5. The device as defined in claim 1, wherein the jointing portion is at least a board hole.

6. The device as defined in claim 1, wherein a flange portion is disposed near the free end of the axle and a clip-in portion is disposed corresponding to the axle hole, such that the flange portion and the clip-in portion may be clipped together.

7. The device as defined in claim 1, wherein the axle is fabricated to form an axle groove, which may be linked with the cut groove to receive lubricating grease.
